(19) United States
(12) Patent Application Publication
(10) Pub. No.: US 2024/0402585 A1
(43) Pub. Date: Dec. 5, 2024

(54) WAVELENGTH CONVERSION MODULE AND PROJECTION DEVICE

(71) Applicant: Coretronic Corporation, Hsin-Chu (TW)

(72) Inventors: Jia-Hong Dai, Hsin-Chu (TW); Te-Ying Tsai, Hsin-Chu (TW); Shao-Peng Su, Hsin-Chu (TW)

(73) Assignee: Coretronic Corporation, Hsin-Chu (TW)

(21) Appl. No.: 18/665,511

(22) Filed: May 15, 2024

Related U.S. Application Data
(60) Provisional application No. 63/470,992, filed on Jun. 5, 2023.

(30) Foreign Application Priority Data
Aug. 10, 2023 (CN) 202311003464.3

(51) Int. Cl. G03B 21/20; G02B 26/00

(52) U.S. Cl. CPC G03B 21/204; G02B 26/008; G03B 21/208

(57) ABSTRACT

A wavelength conversion module includes a wavelength conversion unit, a support bracket, a lens holder, a condenser lens, and a thermally conductive material. The wavelength conversion unit is disposed on the support bracket. The lens holder is disposed on the support bracket, and has an accommodation space to accommodate the condenser lens. An inner wall of the lens holder is arranged with a bearing surface. The condenser lens has an annular assembly surface. The condenser lens is disposed on the bearing surface through the annular assembly surface to be fixed to the lens holder. The thermally conductive material is disposed between the annular assembly surface of the condenser lens and the bearing surface of the lens holder to transfer heat from the condenser lens to the lens holder.

### CROSS-REFERENCE TO RELATED APPLICATION

This application claims the priority benefits of U.S. provisional application Ser. No. 63/470,992, filed on Jun. 5, 2023 and China application serial no. 202311003464.3, filed on Aug. 10, 2023. The entirety of each of the above-mentioned patent applications is hereby incorporated by reference herein and made a part of this specification.

### BACKGROUND

### Technical Field

The disclosure relates to an optical device, and in particular to a wavelength conversion module and a projection device adopting the wavelength conversion module.

### Description of Related Art

In a current laser projector, color light is generated by use of laser phosphor. A phosphor wheel of the laser projector includes, for example, a rotary disk and phosphor disposed on the rotary disk. A condenser lens is provided in front of the phosphor wheel. The condenser lens is configured to receive incident light and emission light which is generated by excitation of the phosphor and reflected by the rotary disk. The condenser lens that is closest to the phosphor wheel has to withstand residual energy of the incident light and the emissive light, and has a relatively small lens size. Thus, when the incident light energy increases, the lens may undergo a large temperature rise and may crack.

Currently, a commonly used method for dissipating heat from the condenser lens uses a wind flow generated by rotation of the phosphor wheel. When rotating at 7200 rpm to 14400 rpm, the phosphor wheel drives the surrounding air to flow, thereby cooling the condenser lens and a lens holder. However, rotation at such a high speed may lead to large vibration and system noise. Furthermore, as a projection system is reduced in size, the condenser lens is reduced in volume. If the brightness of the system is maintained, the condenser lens may undergo a sharp temperature rise if the heat dissipation capability per unit surface area of the condenser lens is not effectively improved. In addition, due to the manufacturing process limitations of the condenser lens, the surface of the condenser lens contacting with the lens holder is a ground surface instead of a polished surface. Accordingly, heat is not effectively transferred from the condenser lens to the lens holder through such surface.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides a wavelength conversion module which has favorable efficiency in heat dissipation.

The disclosure further provides a projection device which includes the above-mentioned wavelength conversion module and exhibits improved projection quality and product competitiveness.

Other objectives and advantages of the disclosure may be further understood from the technical features disclosed in the disclosure.

In order to achieve one, part or all of the above objectives or other objectives, an embodiment of the disclosure provides a wavelength conversion module which includes a wavelength conversion unit, a support bracket, a lens holder, a condenser lens, and a thermally conductive material. The wavelength conversion unit is disposed on the support bracket. The lens holder is disposed on the support bracket, and has an accommodation space to accommodate the condenser lens. An inner wall of the lens holder is arranged with a bearing surface. The condenser lens has an annular assembly surface. The condenser lens is disposed on the bearing surface through the annular assembly surface to be fixed to the lens holder. The thermally conductive material is disposed between the annular assembly surface of the condenser lens and the bearing surface of the lens holder to transfer heat from the condenser lens to the lens holder.

In order to achieve one, part or all of the above objectives or other objectives, an embodiment of the disclosure provides a projection device which includes an illumination system, a light valve, and a projection lens. The illumination system is configured to provide an illumination beam. The illumination system includes a light source module and a wavelength conversion module. The light source module is configured to emit a laser beam. The wavelength conversion module is located on a transmission path of the laser beam. The wavelength conversion module includes a wavelength conversion unit, a support bracket, a lens holder, a condenser lens, and a thermally conductive material. The wavelength conversion unit is disposed on the support bracket. The lens holder is disposed on the support bracket, and has an accommodation space to accommodate the condenser lens. An inner wall of the lens holder is arranged with a bearing surface. The condenser lens has an annular assembly surface. The condenser lens is disposed on the bearing surface through the annular assembly surface to be fixed to the lens holder. The thermally conductive material is disposed between the annular assembly surface of the condenser lens and the bearing surface of the lens holder to transfer heat from the condenser lens to the lens holder. The light valve is disposed on a transmission path of the illumination beam and is configured to convert the illumination beam into an image beam. The projection lens is disposed on a transmission path of the image beam and is configured to project the image beam out of the projection device.

Based on the above, embodiments of the disclosure have at least one of the following advantages or effects. In the design of the wavelength conversion module of the disclosure, the thermally conductive material is disposed between the annular assembly surface of the condenser lens and the bearing surface of the lens holder, and may transfer heat from the condenser lens to the lens holder, thereby effectively dissipating heat from the condenser lens. In other words, the wavelength conversion module of the disclosure may have favorable efficiency in heat dissipation, and the projection device adopting the wavelength conversion module of the disclosure may exhibit improved projection quality and product competitiveness.

Other objectives, features, and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a projection device according to an embodiment of the disclosure.

FIG. 2A is a schematic three-dimensional view of a wavelength conversion module of the projection device in FIG. 1.

FIG. 2B is a schematic side view of the wavelength conversion module in FIG. 2A.

FIG. 2C is a schematic top view of a condenser lens and a lens holder of the wavelength conversion module in FIG. 2A.

FIG. 2D is a schematic three-dimensional exploded view of FIG. 2C.

FIG. 2E is a schematic cross-sectional view along line I-I of FIG. 2C.

FIG. 3 is a schematic three-dimensional view of an annular elastic piece according to an embodiment of the disclosure.

FIG. 4A is a schematic top view of a condenser lens and a lens holder of a wavelength conversion module according to another embodiment of the disclosure.

FIG. 4B is a schematic side view of FIG. 4A.

FIG. 5 is a schematic side view of a wavelength conversion module according to another embodiment of the disclosure.

FIG. 6A is a schematic top view of a condenser lens and a lens holder of a wavelength conversion module according to another embodiment of the disclosure.

FIG. 6B is a schematic three-dimensional exploded view of FIG. 6A.

FIG. 6C is a schematic cross-sectional view along line II-II of FIG. 6A.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the FIG.(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

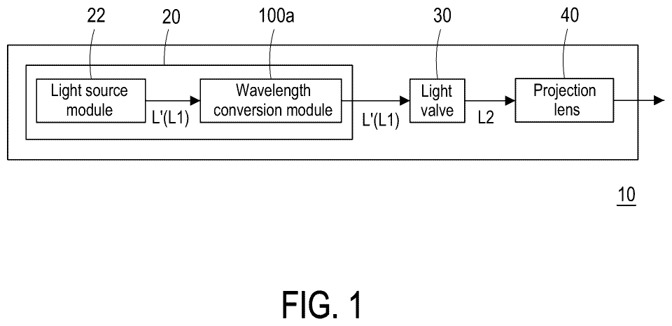

FIG. 1 is a schematic view of a projection device according to an embodiment of the disclosure. First, referring to FIG. 1, in this embodiment, a projection device 10 includes an illumination system 20, a light valve 30, and a projection lens 40. The illumination system 20 is configured to provide an illumination beam L1. The illumination system 20 includes a light source module 22 and a wavelength conversion module 100a. The light source module 22 is configured to emit a laser beam L′. The wavelength conversion module 100a is located on a transmission path of the laser beam L′ and is suitable for converting the laser beam L′ into at least one color light, and the color of the at least one color light is different from the color of the laser beam L′. The illumination beam L1 includes at least one of the laser beam L′ and the at least one color light. The light valve 30 is disposed on a transmission path of the illumination beam L1 and is configured to convert the illumination beam L1 into an image beam L2. The projection lens 40 is disposed on a transmission path of the image beam L2 and is configured to project the image beam L2 out of the projection device 10.

Specifically, the light source module 22 used in this embodiment is, for example, a laser diode (LD), such as a laser diode bank. The light source module 22 may further include, for example, a light-emitting diode (LED) or a light-emitting diode bank. The light source module 22 may be, for example, a combination of a light-emitting diode and a laser diode. Specifically, any light source which meets the volume requirement may be implemented according to the actual design, and the disclosure is not limited thereto. The light valve 30 is, for example, a reflective optical modulator such as a liquid crystal on silicon panel (LCoS panel) or a digital micro-mirror device (DMD). In an embodiment, the light valve 30 is, for example, a transmissive optical modulator such as a transparent liquid crystal panel, an electro-optical modulator, a magneto-optic modulator, or an acousto-optic modulator (AOM), but this embodiment does not limit the light valve 30 to a certain type or form. Detail steps and implementation manner of a method for modulating the illumination beam L1 into the image beam L2 by the light valve 30 will be omitted since sufficient teachings, suggestions and descriptions of implementation can be obtained from common knowledge in the art. The projection lens 40 includes, for example, one optical lens or a combination of multiple optical lenses with a diopter, such as various combinations of non-planar lenses including biconcave lenses, biconvex lenses, concave-convex lenses, convex-concave lenses, plano-convex lenses, and plano-concave lenses. In an embodiment, the projection lens 40 may also include a planar optical lens. The projection lens projects the image beam L2 from the light valve 30 out of the projection device 10 in a reflective or a transmissive manner. Here, this embodiment does not limit the projection lens 40 to a certain type or form.

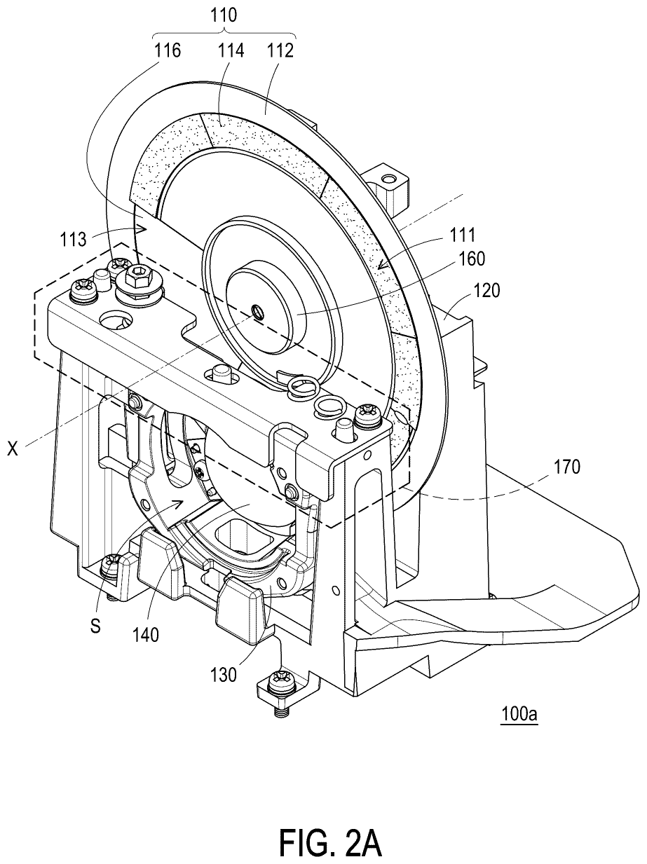

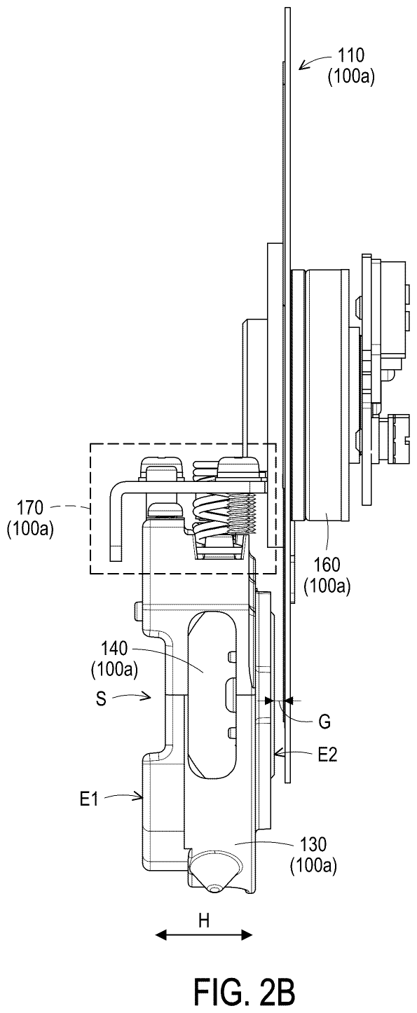

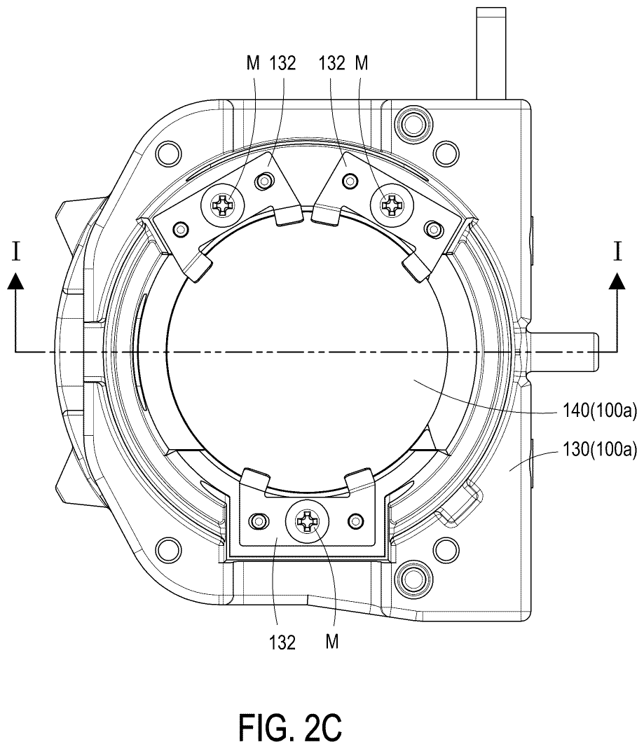

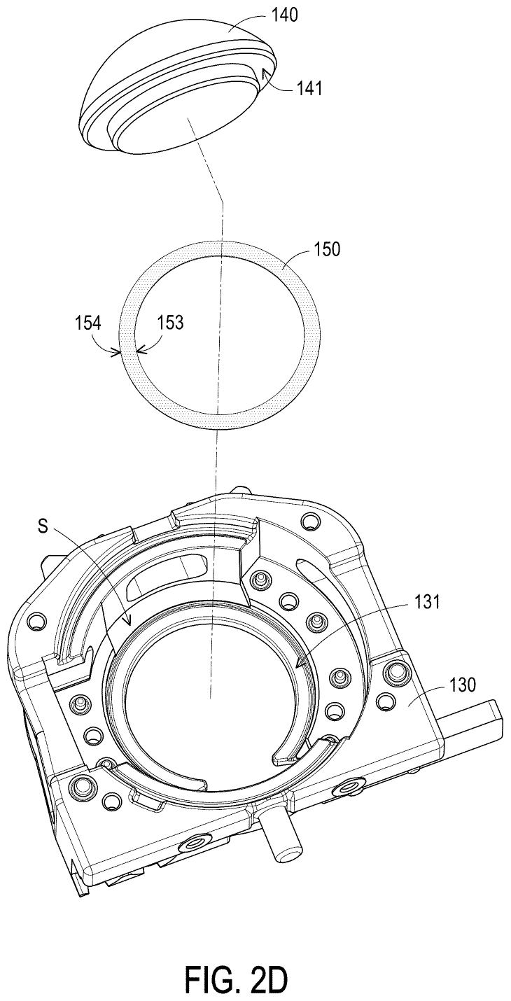

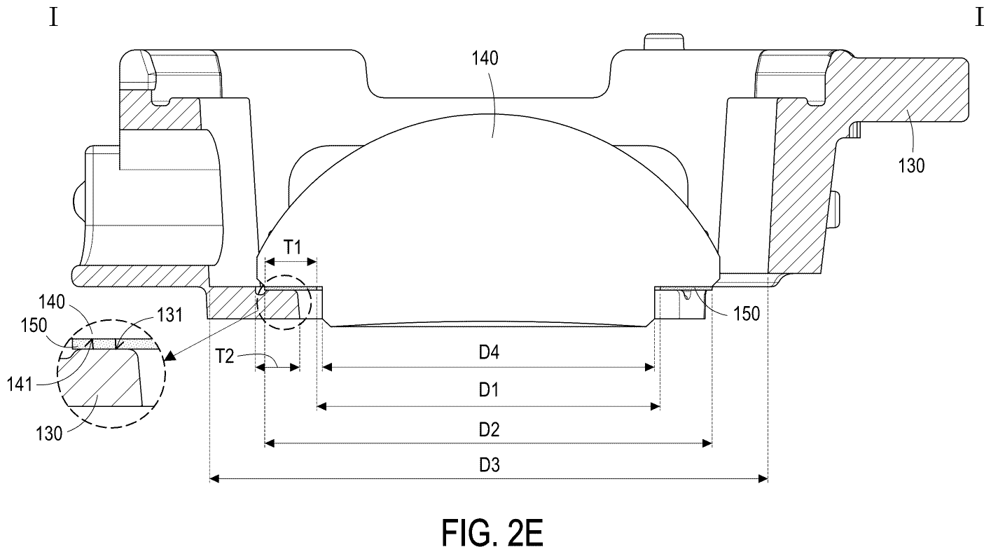

FIG. 2A is a schematic three-dimensional view of a wavelength conversion module of the projection device in FIG. 1. FIG. 2B is a schematic side view of the wavelength conversion module in FIG. 2A. FIG. 2C is a schematic top view of a condenser lens and a lens holder of the wavelength conversion module in FIG. 2A. FIG. 2D is a schematic three-dimensional exploded view of FIG. 2C. FIG. 2E is a schematic cross-sectional view along line I-I of FIG. 2C. For clarity, the support bracket is omitted from FIG. 2B, and the elastic piece is omitted from FIG. 2D.

Referring to FIG. 2A, FIG. 2C, FIG. 2D, and FIG. 2E together, in this embodiment, the wavelength conversion module 100a includes a wavelength conversion unit 110, a support bracket 120, a lens holder 130, a condenser lens 140, and a thermally conductive material 150. The wavelength conversion unit 110 is disposed on the support bracket 120. The lens holder 130 is disposed on the support bracket 120 and has an accommodation space S to accommodate the condenser lens 140. An inner wall of the lens holder 130 is arranged with a bearing surface 131, and the condenser lens 140 has an annular assembly surface 141. The annular assembly surface 141 is, for example, located in an edge region on a surface of the condenser lens 140 toward the wavelength conversion unit 110, where the condenser lens 140 is disposed on the bearing surface 131 through the annular assembly surface 141 to be fixed to the lens holder 130. The thermally conductive material 150 is disposed between the annular assembly surface 141 of the condenser lens 140 and the bearing surface 131 of the lens holder 130 to transfer heat from the condenser lens 140 to the lens holder 130. The lens holder 130 is made of, for example, a material with high thermal conductivity. In this embodiment, the lens holder 130 is, for example, a metal material.

Specifically, referring to FIG. 2A, in this embodiment, the wavelength conversion unit 110 is embodied as a wavelength conversion wheel which includes a rotary disk 112 and a wavelength conversion layer 114 disposed on the rotary disk 112. The condenser lens 140 and the wavelength conversion layer 114 are located on the same side of the rotary disk 112, where the condenser lens 140 is located in front of the wavelength conversion unit 110, that is, on the incident light side of the wavelength conversion unit 110 which receives the laser beam (for example, L′ in FIG. 1). Here, the wavelength conversion layer 114 is, for example, yellow phosphor, but is not limited thereto. Furthermore, the wavelength conversion unit 110 of this embodiment has a light conversion region 111 and a non-light conversion region 113. The light conversion region 111 may convert the laser beam L′ (referring to FIG. 1) from the light source module 20 into a converted beam with a different color. That is, the light conversion region 111 changes the wavelength of the laser beam L′, while the non-light conversion region 113 may allow the laser beam L′ (referring to FIG. 1) from the light source module 22 to directly pass therethrough. The wavelength conversion layer 114 is located in the light conversion region 111, and the non-light conversion region 113 is, for example, disposed with a light-transmitting plate 116 or a hollowed-out region of the rotary disk 112. In the embodiment of FIG. 2A, the light-transmitting plate 116 is used as the non-light conversion region 113, and the light-transmitting plate 116 and the rotary disk 112 are combined into a complete disk shape. Here, a material of the light-transmitting plate 116 is, for example, glass or plastic, and the wavelength conversion unit 110 is, for example, a phosphor wheel.

Furthermore, the wavelength conversion module 100a of this embodiment further includes a driving component 160, where the driving component 160 is connected to the wavelength conversion unit 110 to drive the wavelength conversion unit 110 to rotate around an axis X as a center. More specifically, the driving component 160 is, for example, connected to the center (the center of a circle) of the rotary disk 112 and enables the wavelength conversion unit 110 to rotate around the center. That is to say, the wavelength conversion unit 110 of this embodiment is embodied as a moving member. By the wavelength conversion unit 110 which is rotatable and drives the surrounding air to form an air flow field, heat from the lens holder 130 with a larger area and the condenser lens 140 can be dissipated. However, the disclosure is not limited thereto. In another unillustrated embodiment, the wavelength conversion unit may be a non-moving member, which still falls within the scope of protection of the disclosure.

Next, referring to FIG. 2B, in this embodiment, the lens holder 130 has a light inlet E1 and a light outlet E2, and the accommodation space S connects the light inlet E1 and the light outlet E2. The laser beam L′ from the light source module 22 is incident from the light inlet E1 of the lens holder 130, passes through the condenser lens 140, exits from the light outlet E2 of the lens holder 130, and then is incident to the wavelength conversion unit 110. Referring to FIG. 2C and FIG. 2D together, the lens holder 130 of this embodiment includes a plurality of elastic pieces 132, where the plurality of elastic pieces 132 press against the condenser lens 140 from the opposite side of the annular assembly surface 141 of the condenser lens 140, and the plurality of elastic pieces 132 are arranged to be spaced apart from each other, so that the condenser lens 140 is in close contact with the bearing surface 131 through the thermally conductive material 150. In other words, the condenser lens 140, the bearing surface 131 and the thermally conductive material 150 are closely pressed together, so that the contact between the condenser lens 140 and the bearing surface 131 is closely, and the contact between the bearing surface 131 and thermally conductive material 150 is also closely. Thus, heat transfer performance may be improved. In the embodiment illustrated in FIG. 2B, FIG. 2C, and FIG. 2D, the annular assembly surface 141 of the condenser lens 140 is, for example, toward the light outlet E2 of the lens holder 130. The elastic pieces 132, for example, press against an outer surface of the condenser lens 140 toward the light outlet E2. Here, the plurality of elastic pieces 132 are, for example, separated and respectively fixed on the lens holder 130. In an embodiment, one end of each elastic piece 132 is, for example, fastened to the lens holder 130 through a fastening member M such as a screw, and the other end of the elastic piece 132 presses against the condenser lens 140.

Furthermore, referring to FIG. 2A and FIG. 2B again, the wavelength conversion module 100a of this embodiment further includes an adjustment member 170, where the adjustment member 170 is disposed on the lens holder 130 and is configured to adjust a distance G between the condenser lens 140 and the wavelength conversion unit 110. The lens holder 130 is movable along a front-back direction H through the adjustment member 170. That is to say, the distance G is variable in a direction parallel to the axis X, and is a variable distance. Accordingly, a light spot size may be adjusted. Specifically, the adjustment member 170, for example, is used to adjust the distance G between the condenser lens 140 and the rotary disk 112 of the wavelength conversion unit 110 by a person who assembles in order to obtain an optimal light spot size before the projection device 10 leaves the factory.

Referring to FIG. 2D again, the thermally conductive material 150 of this embodiment is annular in shape corresponding to the shape of the annular assembly surface 141 of the condenser lens 140. That is, the thermally conductive material 150 is embodied as an annular thermally conductive material, but is not limited thereto. Here, the thermally conductive material 150 is, for example, a non-silicon-based material such as a graphite sheet. The thermally conductive material 150 has a thermal conductivity coefficient of greater than or equal to 2 W/mK. Since the thermally conductive material 150 has a soft surface, is compressible and can fill gaps, a gap between the annular assembly surface 141 of the condenser lens 140 and the bearing surface 131 of the lens holder 130 can be filled by the thermally conductive material 150. In another embodiment, the thermally conductive material 150 may have a C shape corresponding to the shape of the bearing surface 131, or the thermally conductive material 150 may be, for example, a plurality of material segments arranged to be spaced apart on the bearing surface 131 or the annular assembly surface 141, which still falls within the scope of protection of the disclosure.

Next, referring to FIG. 2D and FIG. 2E together, in order to ensure the maximum contact area between the annular assembly surface 141 of the condenser lens 140 and the bearing surface 131 of the lens holder 130, the annular thermally conductive material 150 of the embodiment in FIG. 2D, for example, needs to satisfy the following conditions. The annular thermally conductive material 150 includes an inner peripheral edge 153 and an outer peripheral edge 154. An inner diameter of the thermally conductive material 150 is D1. The so-called inner diameter D1 is defined as a length of a straight line connecting two points on the inner peripheral edge 153 of the thermally conductive material 150, where the straight line passes through the center of the circle O of the thermally conductive material 150. An outer diameter of the thermally conductive material 150 is D2. The so-called outer diameter D2 is defined as a length of a straight line connecting two points on the outer peripheral edge 154 of the thermally conductive material 150, where the straight line passes through the center of the circle O of the thermally conductive material 150. A radial width of the thermally conductive material 150 is T1, and T1=½(D2−D1). Furthermore, the bearing surface 131 of the lens holder 130 extends from the inner wall toward the accommodation space S, where a diameter of the accommodation space S of the lens holder 130 is D3, a diameter of a curved surface of the condenser lens 140 is D4, a radial width of the bearing surface 131 is T2, and D2≤D3, D4≤D1 and T1>T2. It should be noted that the diameter D3 is the diameter of the accommodation space S in which the condenser lens 140 may be placed, the diameter D4 of the curved surface is a diameter of a surface of the condenser lens 140 toward the wavelength conversion unit 110, and the radial width T2 is a width in the radial direction of the bearing surface 131 of the lens holder 130 that bears the condenser lens 140.

In short, in this embodiment, the temperature of the condenser lens 140 may be reduced by the thermally conductive material 150. Further, in this embodiment, thermal resistance between the condenser lens 140 and the lens holder 130 can be reduced, so that heat from the condenser lens 140 can be transferred to the lens holder 130 with large area through the thermally conductive material 150 for heat dissipation. Meanwhile, the heat dissipation of the lens holder 130 can also be performed by a flow field driven by rotation of the wavelength conversion unit 110. Thus, the temperature of the condenser lens 140 can be reduced without adjusting the lens holder 130. In a simulation experiment, an edge temperature of the condenser lens 140 may be reduced by 11° C. (that is, reduced by 11%) by the thermally conductive material 150.

Other embodiments will be described below as examples. It should be noted here that the reference numerals and a part of the content of the foregoing embodiments will be applied to the following embodiments, where the same reference numerals are used to represent the same or similar elements, and descriptions of the same technical contents will be omitted. Please refer to the foregoing embodiments for the omitted descriptions which will not be repeated in the following embodiments.

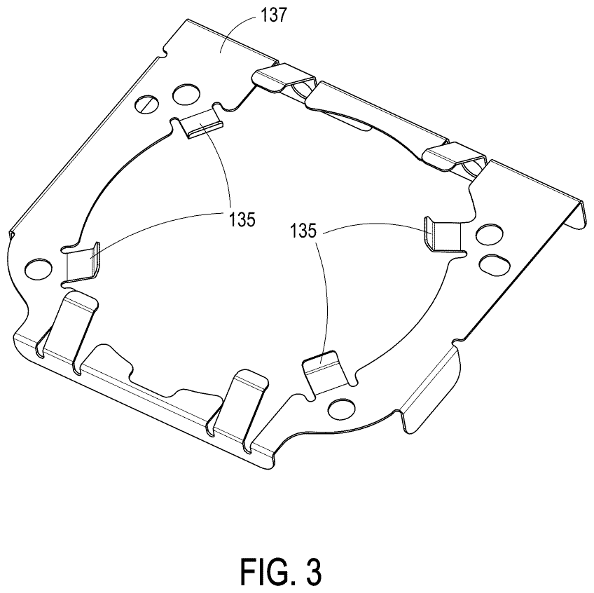

FIG. 3 is a schematic three-dimensional view of an annular elastic piece according to an embodiment of the disclosure. Referring to FIG. 2C, FIG. 2D, and FIG. 3 together, an elastic piece 135 of this embodiment is similar to the elastic piece 132 in FIG. 2C, and the main differences between the two lie in that: in this embodiment, a plurality of elastic pieces 135 are integrally formed on a frame 137 into a one-piece element, that is, an integrated annular pressed elastic piece. The frame 137 has an annular central hole (not labeled) corresponding to the condenser lens. The plurality of elastic pieces 135 extend from an inner edge of the frame 137 toward the center of the annular central hole, and the frame 137 may be fixed on the lens holder 130 (referring to FIG. 2C and FIG. 2D) to ensure close contact between the annular assembly surface 141 of the condenser lens 140 and the bearing surface 131 of the lens holder 130. Thus, heat transfer performance may be improved. The frame 137 may be, for example, annular as a whole.

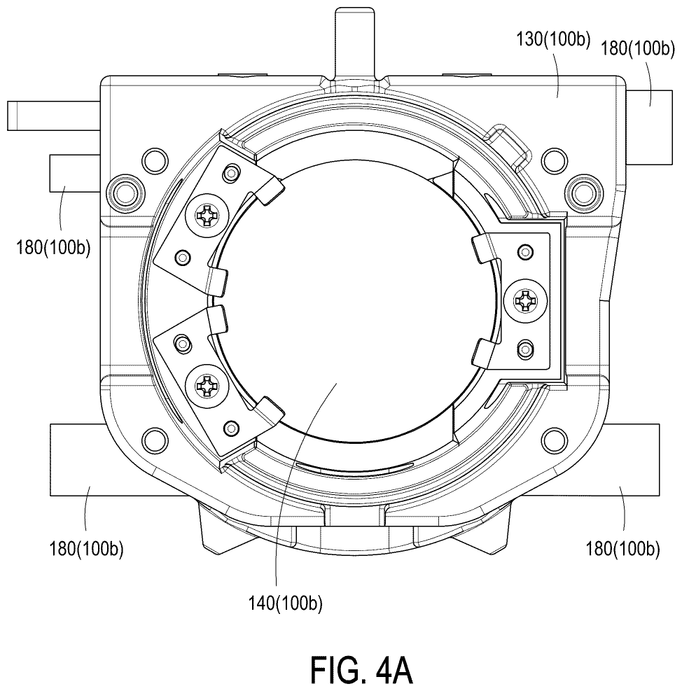

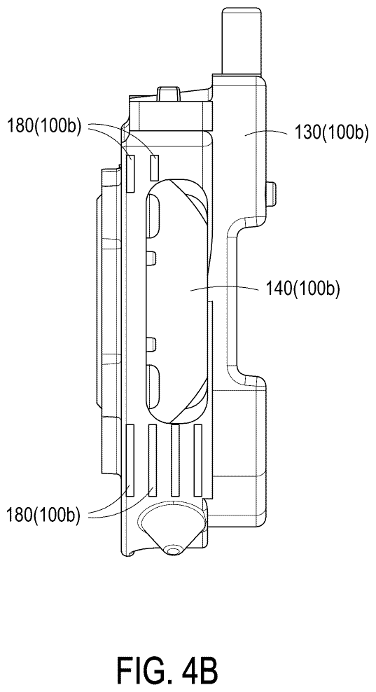

FIG. 4A is a schematic top view of a condenser lens and a lens holder of a wavelength conversion module according to another embodiment of the disclosure. FIG. 4B is a schematic side view of FIG. 4A. Referring to FIG. 2C, FIG. 4A, and FIG. 4B together, a wavelength conversion module 100b of this embodiment is similar to the wavelength conversion module 100a in FIG. 2C, and the main differences between the two lie in that: in this embodiment, the wavelength conversion module 100b further includes a heat dissipation fin group 180 disposed on an outer peripheral surface of the lens holder 130. The heat dissipation fin group 180 includes, for example, a plurality of protruding flake-like heat dissipation fins extending outward from the outer peripheral surface of the lens holder 130. Accordingly, heat dissipation area of the lens holder 130 is increased, thereby reducing the temperature of the condenser lens 140. In an unillustrated embodiment, the heat dissipation fin group may include a plurality of protruding columnar heat dissipation fins. In another unillustrated embodiment, the lens holder and the heat dissipation fin group may have an integrally formed structure.

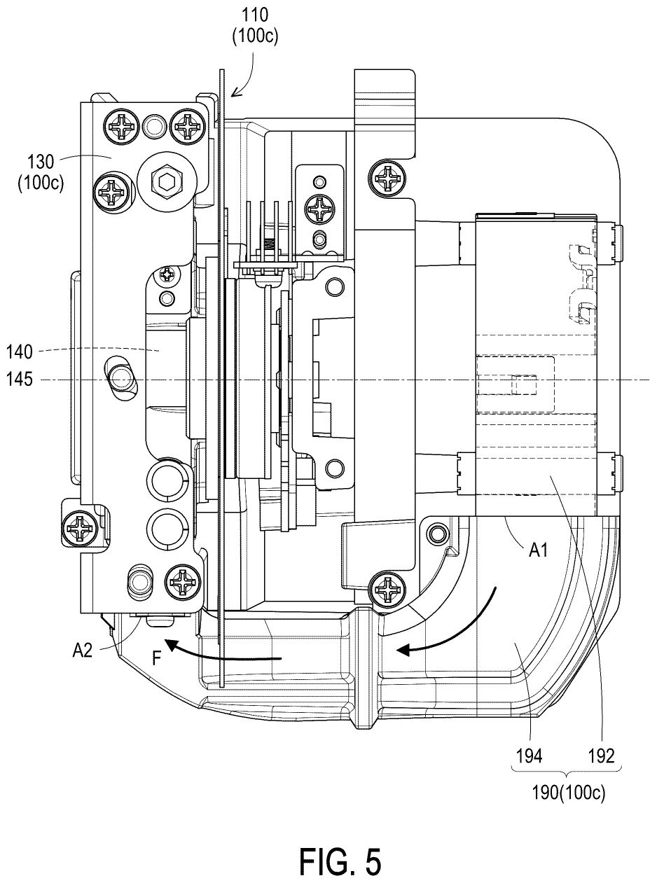

FIG. 5 is a schematic side view of a wavelength conversion module according to another embodiment of the disclosure. Referring to FIG. 2B and FIG. 5 together, a wavelength conversion module 100c of this embodiment is similar to the wavelength conversion module 100a in FIG. 2B, and the main differences between the two lie in that: in this embodiment, the wavelength conversion module 100c further includes a wind flow generating device 190. The wind flow generating device 190 includes a fan 192 and a wind guide structure 194. An air inlet A1 of the wind guide structure 194 is toward the fan 192, and an air outlet A2 of the wind guide structure 194 is, for example, adjacent to the lens holder 130. A cooling wind flow F generated by the fan 192 is blown toward the lens holder 130 through the wind guide structure 194, where the cooling wind flow F flowing out from the air outlet A2 of the wind guide structure 194 is not parallel to an optical axis 145 of the condenser lens 140. The temperature of the lens holder 130 and the condenser lens 140 may further be reduced through the wind flow generating device 190. In this embodiment, the fan 192 and the wind guide structure 194 may be connected to each other, and the wavelength conversion unit 110 is, for example, disposed between the fan 192 and the condenser lens 140, but is not limited thereto. In other embodiments, the fan may be disposed at other positions in the projection device, as long as the wind guide structure is able to guide the cooling wind flow to the lens holder 130.

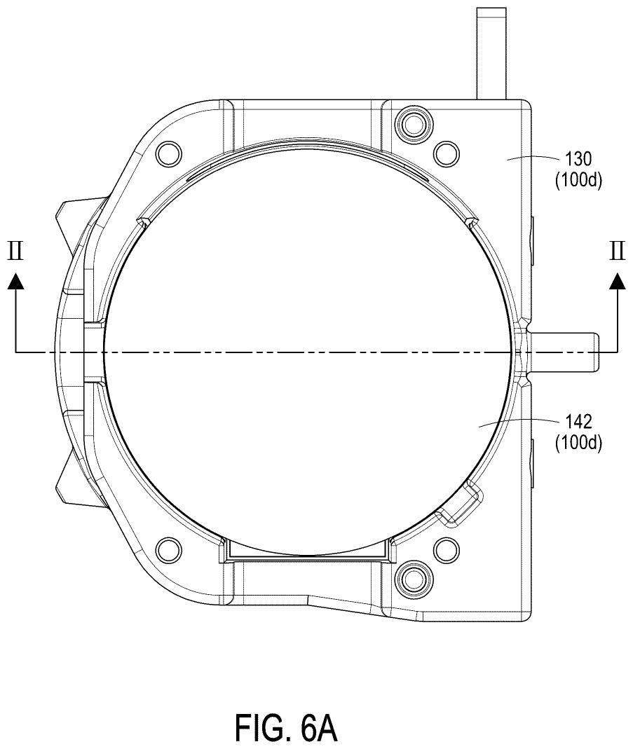

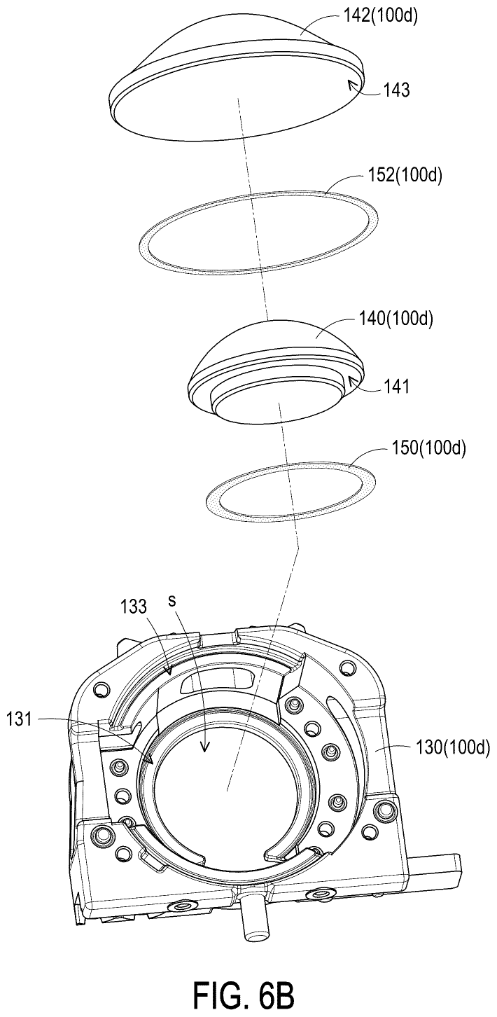

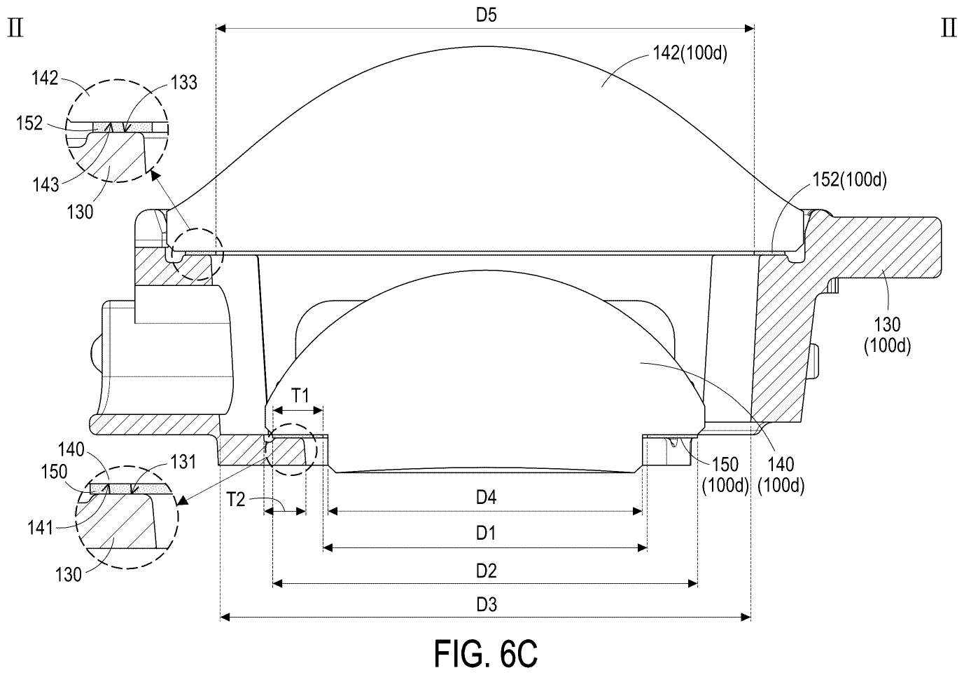

FIG. 6A is a schematic top view of a condenser lens and a lens holder of a wavelength conversion module according to another embodiment of the disclosure. FIG. 6B is a schematic three-dimensional exploded view of FIG. 6A. FIG. 6C is a schematic cross-sectional view along line II-II of FIG. 6A. Referring to FIG. 2C, FIG. 2D, FIG. 6A, FIG. 6B, and FIG. 6C together, a wavelength conversion module 100d of this embodiment is similar to the wavelength conversion module 100a in FIG. 2C, and the main differences between the two lie in that: in this embodiment, the wavelength conversion module 100d further includes another condenser lens 142 and another thermally conductive material 152. The another condenser lens 142 has another annular assembly surface 143. The inner wall of the lens holder 130 is further arranged with another bearing surface 133. The another thermally conductive material 152 is disposed between the another annular assembly surface 143 of the another condenser lens 142 and the another bearing surface 133 of the lens holder 130. The temperature of the condenser lens 140 and the another condenser lens 142 may be reduced by the thermally conductive material 150 and the another thermally conductive material 152. Here, the another condenser lens 142 is larger in size than the condenser lens 140, and an inner diameter D5 of the another thermally conductive material 152 is larger than the inner diameter D1 of the thermally conductive material 150. The so-called inner diameter D5 is defined as distance length of a straight line connecting two points on an inner peripheral edge of the another thermally conductive material 152, where the straight line passes through the center (not illustrated) of the circle of the another thermally conductive material 152.

To sum up, embodiments of the disclosure have at least one of the following advantages or effects. In the design of the wavelength conversion module of the disclosure, the thermally conductive material is disposed between the annular assembly surface of the condenser lens and the bearing surface of the lens holder, and may transfer heat from the condenser lens to the lens holder, thereby effectively dissipating heat from the condenser lens. In other words, the wavelength conversion module of the disclosure may have favorable efficiency in heat dissipation, and the projection device adopting the wavelength conversion module of the disclosure may exhibit improved projection quality and product competitiveness.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A wavelength conversion module, comprising: a wavelength conversion unit, a support bracket, a lens holder, a condenser lens, and a thermally conductive material, wherein
the wavelength conversion unit is disposed on the support bracket;
the lens holder is disposed on the support bracket and has an accommodation space to accommodate the condenser lens, and an inner wall of the lens holder is arranged with a bearing surface;
the condenser lens has an annular assembly surface, and is disposed on the bearing surface through the annular assembly surface to be fixed to the lens holder; and
the thermally conductive material is disposed between the annular assembly surface of the condenser lens and the bearing surface of the lens holder.

2. The wavelength conversion module according to claim 1, further comprising:
a driving component, wherein the wavelength conversion unit is a wavelength conversion wheel, and the driving component is connected to the wavelength conversion wheel to drive the wavelength conversion wheel to rotate around an axis as a center.

3. The wavelength conversion module according to claim 2, wherein the wavelength conversion wheel comprises a rotary disk and a wavelength conversion layer disposed on the rotary disk, and the condenser lens and the wavelength conversion layer are located on a same side of the rotary disk.

4. The wavelength conversion module according to claim 3, wherein the wavelength conversion wheel further comprises a light-transmitting plate, the wavelength conversion wheel has a light conversion region and a non-light conversion region, the wavelength conversion layer is located in the light conversion region, and the light-transmitting plate is located in the non-light conversion region and defines a disk shape with the rotary disk.

5. The wavelength conversion module according to claim 1, further comprising:
an adjustment member, disposed on the lens holder and configured to adjust a distance between the condenser lens and the wavelength conversion unit.

6. The wavelength conversion module according to claim 1, wherein an inner diameter of the thermally conductive material is D1, an outer diameter of the thermally conductive material is D2, a radial width of the thermally conductive material is T1, and T1=½(D2−D1).

7. The wavelength conversion module according to claim 6, wherein the bearing surface of the lens holder extends from the inner wall toward the accommodation space, a diameter of the accommodation space of the lens holder is D3, an inner diameter of a curved surface of the condenser lens is D4, a radial width of the bearing surface is T2, and D2≤D3, D4<D1 and T1>T2.

8. The wavelength conversion module according to claim 1, wherein the lens holder comprises a plurality of elastic pieces, the plurality of elastic pieces press against the condenser lens from an opposite side of the annular assembly surface, and the plurality of elastic pieces are arranged to be spaced apart from each other, so that the condenser lens, the bearing surface and the thermally conductive material are pressed closely.

9. The wavelength conversion module according to claim 8, wherein the plurality of elastic pieces are respectively fixed on the lens holder, or the plurality of elastic pieces are integrally formed on a frame, and the frame is fixed on the lens holder.

10. The wavelength conversion module according to claim 1, further comprising:
a heat dissipation fin group, disposed on an outer peripheral surface of the lens holder.

11. The wavelength conversion module according to claim 1, further comprising:
a wind flow generating device, comprising a fan and a wind guide structure, wherein a cooling wind flow generated by the fan is blown toward the lens holder.

12. The wavelength conversion module according to claim 1, wherein the thermally conductive material comprises a non-silicon-based material, and a thermal conductivity coefficient of the thermally conductive material is greater than or equal to 2 W/mK.

13. The wavelength conversion module according to claim 1, further comprising:
another condenser lens and another thermally conductive material, wherein the another condenser lens has another annular assembly surface, the inner wall of the lens holder is further arranged with another bearing surface, and the another thermally conductive material is disposed between the another annular assembly surface of the another condenser lens and the another bearing surface of the lens holder.

14. The wavelength conversion module according to claim 1, wherein the thermally conductive material is an annular thermally conductive material.

15. A projection device, comprising: an illumination system, a light valve, and a projection lens, wherein
the illumination system is configured to provide an illumination beam, and the illumination system comprises:
a light source module, configured to emit a laser beam; and
a wavelength conversion module, located on a transmission path of the laser beam, wherein the wavelength conversion module comprises a wavelength conversion unit, a support bracket, a lens holder, a condenser lens, and a thermally conductive material, wherein
the wavelength conversion unit is disposed on the support bracket;
the lens holder is disposed on the support bracket, and has an accommodation space to accommodate the condenser lens, and an inner wall of the lens holder arranged with a bearing surface;
the condenser lens has an annular assembly surface, and is disposed on the bearing surface through the annular assembly surface to be fixed to the lens holder; and
the thermally conductive material is disposed between the annular assembly surface of the condenser lens and the bearing surface of the lens holder;
the light valve is disposed on a transmission path of the illumination beam and configured to convert the illumination beam into an image beam; and
the projection lens is disposed on a transmission path of the image beam and configured to project the image beam out of the projection device.
